(19) United States
(12) Patent Application Publication
(10) Pub. No.: US 2021/0284312 A1
(43) Pub. Date: Sep. 16, 2021

(54) Method and Apparatus for Adjusting the Flow Properties of a Propeller

(71) Applicant: Torqeedo GmbH, Gilching (DE)

(72) Inventors: Jens Biebach, Tutzing (DE); Frank Despineux, Wessling (DE)

(21) Appl. No.: 17/200,247

(22) Filed: Mar. 12, 2021

(30) Foreign Application Priority Data
Mar. 13, 2020 (DE) 10 2020 107 038.1

(51) Int. Cl. B63H 21/21; F03B 17/00; F03B 3/14; B63H 3/10; B63H 21/165

(52) U.S. Cl. CPC B63H 21/21; F03B 17/00; B63H 21/165; B63H 3/10; F03B 3/14

(57) ABSTRACT

The present disclosure relates to a method (1) and an apparatus (10) for adjusting flow properties of a propeller (103) of a propulsion system (100) for watercrafts (1000), in particular for boats and ships, depending on the operation state, comprising the steps of determining the operation state (2) of the propulsion system (100), wherein in the propulsion system (100) either a thrust state or a generator state, in particular a hydrogeneration state for generating energy by hydrogeneration, is present, and adjusting the flow properties (3) of the propeller (103) based on the determined operation state.

### RELATED APPLICATION(S)

This application claims priority to and the benefit of German Patent Application No. DE 10 2020 107 038.1, filed Mar. 13, 2020, which is incorporated herein by reference in its entirety.

### TECHNICAL FIELD

A method and an apparatus for adjusting the flow properties of a propeller of a propulsion system for watercrafts, in particular for boats and ships, depending on the operation state, as well as a propulsion system comprising the apparatus and a watercraft comprising the propulsion system are disclosed.

### BACKGROUND

For the propulsion of watercrafts, propulsion systems that comprise an electric motor as the drive are increasingly being used. Electric motors comprise several advantages over combustion engines. These include an almost constant torque, a very high efficiency and no direct production of combustion products such as carbon dioxide, carbon monoxide and nitric oxides. Batteries or accumulators are used to store energy. However, the storage capacity of batteries and accumulators is limited. A certain degree of autarky is therefore desirable, so that the batteries or accumulators do not have to be recharged as frequently via a power grid, or so that the range can be increased.

The propulsion systems of watercrafts such as boats and ships comprise, among other things, propellers that convert the rotation or the torque of the drive into propulsion or thrust. Propellers comprise propeller blades that are shaped and aligned in such a way that the surrounding medium, in this case water, flows around them obliquely or asymmetrically during the propeller's rotational movement. The propeller blades experience dynamic propulsion, the axial component of which is absorbed by the bearing of the propeller on the one hand and is referred to as thrust, and on the other hand causes an oppositely directed flow of the medium, which is referred to as rotor radiation.

A propeller can also be used to drive a generator to produce electrical energy. If a generator is driven via a propeller by a flow of water, this is called hydrogeneration.

It is known to charge batteries and accumulators, which supply a watercraft's propulsion system with electrical energy, by means of non-grid-connected systems such as solar cells. It is also known to carry hydrogenerators on watercrafts to generate electrical energy for batteries or accumulators. This is done by exploiting flow relative to the watercraft. However, a separate hydrogenerator is an additional system that requires a certain amount of space and weight, which should be avoided, especially for smaller watercrafts.

### SUMMARY

The present disclosure has the task of avoiding or at least alleviating the aforementioned disadvantages and problems of the prior art and, in particular, adjusting flow properties for a propeller of a propulsion system depending on the operation state.

A first aspect relates to a method for adjusting flow properties of a propeller of a propulsion system of a watercraft, in particular for boats and ships, depending on the operation state. The method comprising the steps of:

Determining the operation state of the propulsion system. Either a thrust state or a free state or a blocked state or a generator state, in particular a hydrogeneration state in which energy is generated by hydrogeneration, is present.

Adjusting the flow properties based on the determined operation state.

The steps can be carried out both consecutively or in parallel.

The operation state of the propulsion system can be adjusted automatically or the operation state can initially be set by a user and the user can preferably set a thrust state and/or a free state and/or a blocked state and/or a generator state as the operation state.

This automatically adjusted or user-set operation state is determined.

A second aspect relates to an apparatus for adjusting flow properties for a propeller of a propulsion system of a watercraft, in particular for boats and ships, depending on the operation state. The apparatus comprising a module for determining an operation state and adjusting means for adjusting the flow properties. The module for determining the operation state is configured and arranged to determine the operation state of the propulsion system. Either a thrust state or a free state or a blocked state or a generator state, in particular a hydrogeneration state in which energy is generated by hydrogeneration, is present. The adjustment means for adjusting the flow properties are configured and arranged to adjust the flow properties based on the determined operation state.

A third aspect relates to a propulsion system, in particular a propulsion system for watercraft, in particular for boats and ships. The propulsion system comprises an apparatus as previously described.

A fourth aspect relates to a watercraft. The watercraft comprises a propulsion system as previously described.

The propulsion system can comprise a battery or an accumulator, a drive, in particular an electric motor, optionally a gearbox and a propeller. The drive or electric motor can drive the propeller in the thrust state, optionally via the gearbox. In this case, electrical energy is provided and consumed by the battery or the accumulator. In addition, the drive or electric motor can be operated as a generator in the generator state or hydrogeneration state. In this case, the drive or electric motor is driven by the propeller and electrical energy is delivered to the battery or accumulator.

It is first determined whether the thrust state or the generator state, in particular the hydrogeneration state, is currently present. The module for determining the operation state uses one or more decision criteria to check whether the thrust state or the generator state or the hydrogeneration state is currently present. For example, a control signal that is present when switching from one operation state to the other and/or a measured current from the battery or the accumulator to the drive or the electric motor can be used by the module for determining the operation state as a decision criterion to determine which of the two operation states is currently present.

Based on the determined operation state, the flow properties for the propeller of the propulsion system are adjusted as optimally as possible. For this purpose, factors that influence the flow properties are adjusted directly. The adjustment means for adjusting the flow properties act directly on said factors.

Depending on the operation state, i.e., the thrust state or the generator state, the flow properties are influenced in such a way that they are adjusted in the best possible way for the currently prevailing operation state. In the thrust state, depending on the speed relative to the medium, in particular the speed of the watercraft or boat or ship relative to the water, the flow properties for the propeller can be adjusted. As a rule, there is a high relative speed or velocity with which the watercraft or boat or ship moves through the water. High relative speed in this context is a relative speed of 1 knot to 50 knots, for example, 2 knots to 30 knots and, in some embodiments, 5 knots to 20 knots. In the generator state or the hydrogeneration state, depending on the relative speed of the medium, in particular the speed of the water relative to the watercraft or boat or ship, the flow properties for the propeller can be adjusted.

As a rule, the relative speed or velocity at which the water flows past the watercraft, boat or ship is low. Low relative speed in this context is a relative speed of 7 knots or less, more specifically 5 knots or less and, in some embodiments, preferably 3 knots or less. The different forces acting on the propeller in the two different operation states can also be taken into account when adjusting the flow properties for the propeller. For example, in the thrust state, the propeller is driven by the drive or electric motor and propulsion or thrust is generated by drawing in and discharging medium or water. In the generator state or the hydrogeneration state, the propeller is driven by the medium or water flowing past and electrical energy is generated.

By optimizing the flow properties for a propeller of the propulsion system, the propulsion system can be used both in a thrust state for driving via the propeller and in a generator state or hydrogeneration state for generating electrical energy via the propeller. The flow properties of the propeller are optimized in such a way that it operates as optimally as possible in both operation states.

In some embodiments, when adjusting the flow properties based on the determined operation state, a propeller shape of the propeller is changed or an inflow velocity of the propeller is adjusted.

In some embodiments, the adjustment means for adjusting the flow properties comprise a propeller or adjustment means for adjusting the inflow velocity. The propeller is configured and arranged to change its propeller shape. The inflow velocity adjusting means are configured and arranged to adjust an inflow velocity of the propeller.

The flow properties of the propeller that are adjusted are understood to be the propeller shape and the inflow velocity. By changing the shape of the propeller, an optimal shape can be adjusted for the generation of propulsion or thrust by the propeller on the one hand and for the generation of electrical energy by rotation of the propeller through the medium flowing past on the other hand, depending on the relative speed. By adjusting the inflow velocity, the propeller can operate as optimally as possible in the medium in each of the operation states.

By changing the propeller shape and/or adjusting the inflow velocity, the efficiency of the propulsion system can be maximized in both thrust state and generator state.

In some embodiments, the propeller shape is changed by changing an angle of attack of propeller blades of the propeller or changing an area of the propeller blades or changing the number of propeller blades.

In some embodiments, the propeller is configured and arranged to change an angle of attack of propeller blades of the propeller or an area of the propeller blades or a number of the propeller blades.

The propeller shape is determined by the angle of attack of the propeller blades and/or the area of the individual propeller blades and/or the number of propeller blades. The angle of attack is the angle of a propeller blade relative to the direction of flow or around a radial direction of the propeller along which the propeller blade extends. A large angle of attack results in a large dynamic lift or propulsion and a high hydrodynamic drag. In particular, a large angle of attack can be selected if the propeller rotates slowly or if the relative speed or flow velocity is low.

A small angle of attack results in a small dynamic lift or propulsion and a low hydrodynamic resistance. A small angle of attack can be selected in particular when the propeller is rotating quickly or at high relative speed or flow velocity. An increasing area of the individual propeller blades increases the efficiency in generating propulsion or thrust and vice versa. Here, the area of a propeller blade is also understood to mean the shape of the propeller blade. An increasing number of propeller blades lowers the efficiency, increases the transmittable power, reduces the required diameter of the individual propeller blades and thus the propeller blade speed and increases the running smoothness. The number of propeller blades can be reduced by folding away, folding together or retracting individual propeller blades and vice versa.

By changing the propeller shape by changing the angle of attack, the area and/or the number of propeller blades, the flow properties for the propeller can be adjusted particularly precisely.

The propeller shape can also be adjusted by changing the profile thickness depending on the radius of at least one propeller blade and/or by changing the profile camber of at least one propeller blade and/or by changing the blade retraction of at least one propeller blade and/or by changing the skew of at least one propeller blade.

In some embodiments, the inflow velocity is adjusted by means of a cort nozzle.

In some embodiments, the inflow velocity adjusting means comprise a cort nozzle.

A cort nozzle is a conically tapering ring, profiled like an aerofoil, which surrounds the propeller of a ship or is arranged axially in front of it. Cort nozzles can be rotatably mounted and thus used directly as rudders. By using a cort nozzle, flow losses at the ends of the propeller blades are reduced and a higher mass flow is generated. The geometry of the cort nozzle can be adjustable so that the flow properties for the propeller, in particular the inflow velocity, can be adjusted according to the current operation state.

This leads to an increase in efficiency both in the thrust state and in the generator state. In addition, the calmer afterflow due to the cort nozzle means that the banks and beds of inland waters are less affected.

In some embodiments, a diameter of a nozzle outlet of the cort nozzle is adjusted.

In some embodiments, the cort nozzle is configured and arranged to adjust a diameter of a nozzle outlet of the cort nozzle.

The inflow velocity of the propeller is adjusted, especially in the case of cort nozzles located in front of the propeller, by the diameter of the nozzle outlet. The inflow velocity increases as the diameter of the nozzle outlet decreases and vice versa.

By adjusting the diameter of the nozzle outlet, it is particularly easy to adjust the inflow velocity and thus the flow properties for the propeller as optimally as possible depending on the operation state.

In some embodiments, the diameter of the nozzle outlet is adjusted by rotation of vanes or planes of the cort nozzle.

In some embodiments, the cort nozzle is configured and arranged to adjust the diameter of the nozzle outlet by means of rotation of vanes or planes of the cort nozzle.

The cort nozzle may comprise several conical planes or slightly rounded vanes arranged in a circle in a radial direction around the propeller. By rotating the vanes or planes, the diameter of the nozzle outlet is increased or decreased. Depending on the current operation state, the inflow velocity of the propeller can thus be adjusted.

By rotating the vanes or planes of the cort nozzle, the diameter of the nozzle outlet and thus the inflow velocity of the propeller can be adjusted in a particularly simple manner.

In some embodiments, the cort nozzle can be movable along the propeller axis. This ensures an optimized power transfer from the propeller to the medium or vice versa. The propeller axis is given by the axis around which the propeller blades rotate.

For example, by spacing the nozzle appropriately in front of the propeller, the influence of the cort nozzle on the flow through the propeller in thrust mode can be reduced or increased.

The inflow velocity of the propeller can also be adjusted by at least one flow flap, wherein the flow flap can be arranged in the direction of flow in front of and/or behind the plane formed by the propeller, wherein a pivot axis of the flow flap can be aligned vertically and/or horizontally.

The inflow velocity of the propeller can also be influenced with at least one guide vane, wherein the at least one guide vane can be fixed or movably mounted in the cort nozzle or on the flow flap.

The at least one guide vane is a flow resistor mounted in the cort nozzle or on the flow flap, which can deflect incoming water onto the propeller blades. In this way, for example, the inflow direction and the inflow velocity of the water onto the propeller blades can be adapted or optimally selected.

In particular, when using a cort nozzle with at least one guide vane, a conical, aerofoil-like profile of the cort nozzle can be omitted, or the characteristics of the profile can be kept at least minimal. Alternatively, the guide vane shape can also be adapted to the profile of the cort nozzle or the cort nozzle profile and guide vane shape can be adapted to each other.

If the at least one guide vane is movably mounted, the orientation of the at least one guide vane can be varied in order to adjust and in particular optimize the inflow of the propeller. This can be done, for example, by selecting the angle of attack of the at least one guide vane in such a way that a maximum inflow velocity is present at the propeller blades. If the at least one guide vane is fixed, an optimum inflow velocity and an optimum angle of attack can be specified for a particularly frequent and/or particularly desired, fixed flow condition.

In particular, several guide vanes can be fitted in the cort nozzle or on the flow flap in order to further increase the flow resistance.

In some embodiments, the propeller is connected via a switchable gearbox to a generator for generating energy by hydrogeneration and an adaptation apparatus is provided for adapting the working point of the gearbox depending on the efficiency.

In some embodiments, the propeller of the drive can be pivoted about a vertical pivot axis, for example, pivoted by at least 180°, so that depending on the respective operation mode, an advantageous inflow direction, for example, the respective optimum inflow direction, of the propeller is active.

A vertical pivot axis is a pivot axis that runs parallel to the perpendicular, which is typically perpendicular to the water surface.

For example, when driving or stopping in flowing water, it may be useful to orient the propeller in thrust mode so that the thrust is directed against the direction of flow. In the same water, it can also be useful, for example, to pivot the propeller 180° in a hydrogeneration state so that the flowing water drives the propeller optimally and effective hydrogeneration is ensured. Especially when anchoring or lying at a buoy, the energy of the flowing water can be utilized for hydrogeneration in this way.

In particular, however, when sailing under sail in, for example, still or calm waters, the propeller can be aligned so that it is in the hydrogeneration state, thus ensuring effective hydrogeneration.

In some embodiments, the watercraft is a boat or a ship.

In particular, for boats or ships, the propulsion system can be used as a hydrogenerator in addition to generating propulsion or thrust to drive the boat or ship.

By adjusting and optimizing flow properties for the propeller of the propulsion system depending on the operation state, the efficiency of the propulsion system is maximized in both operation states, namely the thrust state and the hydrogeneration state.

### BRIEF DESCRIPTION OF THE FIGURES

Exemplary further embodiments of the disclosure are explained in more detail by the following description of the figures.

FIG. 1 schematically shows a flow diagram of a method for adjusting flow properties for a propeller of a propulsion system depending on the operation state;

FIG. 2 schematically shows an apparatus for adjusting the flow properties of a propeller depending on a determined operation state of a propulsion system;

FIGS. 3A, 3B, 3C and 3D show schematic representations of propulsion systems for a watercraft; and

FIG. 4 shows a schematic of a boat with a propulsion system comprising an apparatus for adjusting flow properties for a propeller of the propulsion system depending on the operation state.

### DETAILED DESCRIPTION

In the following, exemplary embodiments are described on the basis of the figures. In this context, identical, similar or similarly acting elements are provided with identical reference signs in the different figures, and a repeated description of these elements is partially omitted in order to avoid redundancies.

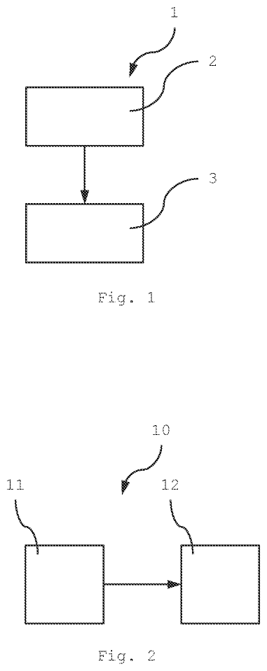

FIG. 1 schematically shows a flow diagram of a method 1 for adjusting the flow properties of a propeller of a propulsion system of a watercraft depending on its operation state 2. The propulsion system may comprise, for example, an electric motor as the drive for driving the propeller.

First, the method determines the operation state 2 of the propulsion system. The propulsion system can be used in a thrust state to generate thrust. In other words, the propulsion system then generates thrust on the watercraft in the water, thereby serving for its locomotion and/or maneuvering. This operation state 2 is a common operation state of a propulsion system for a watercraft.

Alternatively, the propulsion system can also be operated in a generator state to generate electrical energy. The generator state here is a hydrogeneration state in which energy is generated by hydrogeneration. This is achieved by, for example, a propeller being impelled by a movement of the watercraft through the water in such a way that it is driven by the flow and is set in rotation accordingly. This rotation is then converted into electrical energy by the drive. If an electric motor is used as a drive, it can be used directly as a generator.

In a further operation state, the propulsion system can also be operated in a free state in which the individual components are unbraked. For example, a propeller can rotate freely so that it is impelled and rotated by a relative movement through the water.

In a further operation state, the propulsion system can also be in a blocked state in which the individual components are secured against movement and in particular against rotation. In other words, a propeller in the blocked state does not rotate during a relative movement through the water, so that although the water resistance of the watercraft may increase, the wear on the moving components is reduced.

The operation state 2 of the propulsion system can be adjusted automatically or the operation state 2 can initially be set by a user and the user can preferably set a thrust state and/or a free state and/or a blocked state and/or a generator state as operation state 2.

This automatically adjusted or user-set operation state is determined.

After determining the operation state, the flow properties 3 of the propeller are adjusted based on the determined operation state. When adjusting the flow properties 3 based on the determined operation state, a propeller shape of the propeller is changed and/or an inflow velocity of the propeller is adjusted.

The propeller shape can be changed by at least one of the following measures: by changing an angle of attack of at least one propeller blade of the propeller, e.g. by rotating the propeller blade around an individual axis of rotation relative to a hub, by changing an area of at least one propeller blade, e.g. by deforming the propeller blade, e.g. via a movable skeleton covered with a foil, in such a way that its area changes, or by changing the number of propeller blades, e.g. by folding in or retracting individual propeller blades.

Furthermore, the propeller shape can be adjusted by changing the profile thickness depending on the radius of at least one propeller blade 104 and/or by changing the profile camber of at least one propeller blade 104 and/or by changing the blade retraction of at least one propeller blade 104 and/or by changing the skew of at least one propeller blade 104.

Furthermore, the inflow velocity can be adjusted, for example, by means of a cort nozzle, wherein a diameter of a nozzle outlet of the cort nozzle is adjusted by pivoting vanes or planes of the cort nozzle along the axial direction so that the diameter of the nozzle outlet decreases relative to the diameter of the nozzle inlet.

Furthermore, the inflow velocity of the propeller 103 can be adjusted by at least one flow flap 106, wherein the flow flap 106 can be arranged in the direction of flow in front of and/or behind the plane formed by the propeller 103, wherein a pivot axis of the flow flap 106 can be aligned vertically and/or horizontally.

Furthermore, the orientation of the at least one guide vane 107 can be varied in order to adjust and in particular optimize the inflow of the propeller 103.

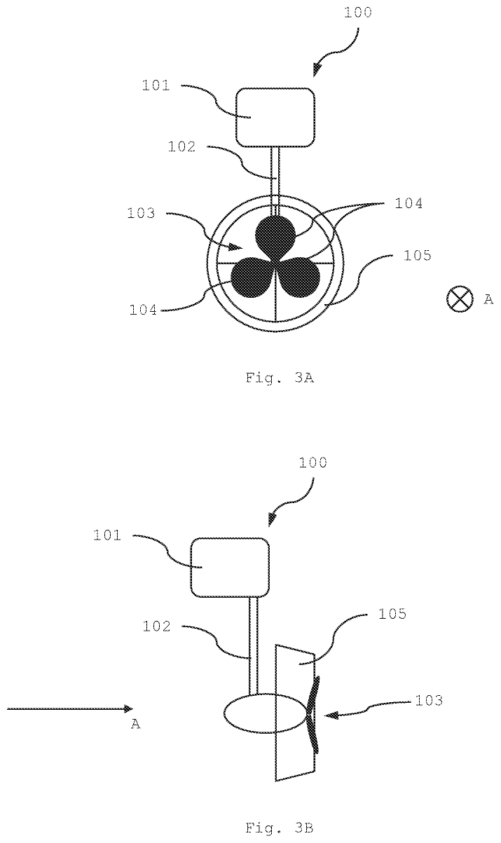

FIG. 2 schematically shows an apparatus 10 for adjusting the flow properties of a propeller of a propulsion system of a watercraft depending on the operation state. The propulsion system may comprise an electric motor as the drive.

The apparatus 10 comprises a module 11 for determining an operation state, which is configured and arranged to determine the current operation state of the propulsion system. For example, either a thrust state or a generator state such as a hydrogeneration state in which energy is generated by hydrogeneration is present.

Furthermore, the apparatus 10 comprises adjusting means 12 for adjusting the flow properties, which are configured and arranged to adjust the flow properties based on the operation state determined with the module 11. The adjusting means 12 for adjusting the flow properties comprise, for example, a propeller. The propeller is configured and arranged to change its propeller shape.

In addition or alternatively, the inflow velocity can be adjusted via the adjusting means 12. The adjusting means for adjusting the inflow velocity are configured and arranged to adjust an inflow velocity of the propeller. The propeller is thereby configured and arranged to change an angle of attack of propeller blades of the propeller and/or an area of the propeller blades and/or a number of the propeller blades. The angle of attack of the propeller blades of the propeller is changed, for example, by rotating the propeller blades about an axis of rotation relative to a hub.

Changing the area of the propeller blades is done, for example, by deforming the propeller blades, e.g. via a movable skeleton covered with a foil, in such a way that their area changes.

Changing the number of propeller blades is done, for example, by retracting in individual propeller blades.

The adjustment means 12 for adjusting the inflow velocity additionally or alternatively comprises, for example, a cort nozzle, wherein the cort nozzle is configured and arranged to adjust a diameter of a nozzle outlet of the cort nozzle by rotating vanes or planes of the cort nozzle.

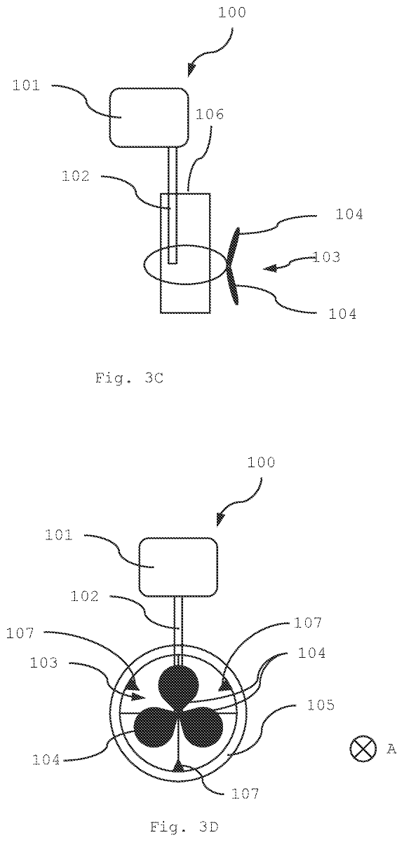

FIGS. 3A and 3B schematically show a propulsion system 100 for watercrafts.

The propulsion system 100 comprises the apparatus 10 as shown in FIG. 2. The propulsion system 100 comprises an electric motor 101 for driving a propeller 103 to rotate. The propulsion system 100 or the electric motor 101 can be used to generate thrust in a thrust state. Alternatively, the propulsion system 100 or the electric motor 101 may also be operated to generate electrical energy in a generator state and thus serve accordingly as a generator. The generator state is here a hydrogeneration state in which energy is generated by hydrogeneration.

For power transmission, the propulsion system 100 comprises a gearbox 102. The gearbox 102 couples the electric motor 101 to the propeller 103. Either the propeller 103 is driven in the thrust state via the gearbox 102 by the electric motor 101, thereby generating thrust, or the electric motor 101 is driven in the generator state or hydrogeneration state via the gearbox 102 by the propeller 103, which is set in motion, for example, by a flow in a river, by a tidal current, by a movement of the watercraft through the water due to the inertia of the watercraft or by a movement of the watercraft with another propulsion—for example, by a sail or a kite.

The gearbox 102 can be designed as a shiftable gearbox 102, wherein an adaptation apparatus is provided for adapting the working point of the gearbox depending on the efficiency. This allows the generator 101 to be operated in the optimum range by shifting the shiftable gearbox 102 accordingly.

In order to be able to perform the respective operation state as optimally as possible, the propeller shape of the propeller 103 can be adapted accordingly. For this purpose, an angle of attack of propeller blades 104 of the propeller 103 can be changed and/or the area of the propeller blades 104 can be changed and/or the number of propeller blades 104 can be changed.

The angle of attack of the propeller blades 104 of the propeller 103 can be changed, for example, by rotating the propeller blades 104 about an axis of rotation relative to a hub. Changing the area of the propeller blades 104 can be done by deforming the propeller blades 104, e.g. via a movable skeleton covered with a foil, in such a way that their area changes. The changing of the number of propeller blades 104 can be done, for example, by retracting individual propeller blades 104.

Additionally or alternatively, the propulsion system 100 may comprise an adjustable cort nozzle 105 that adjusts the inflow velocity of the propeller 103. The cort nozzle 105 is arranged in front of the propeller 103 and can adjust a diameter of a nozzle outlet of the cort nozzle 105 by rotating vanes or planes of the cort nozzle 105.

In FIG. 3C, in some embodiments, instead of the cort nozzle 105 of FIGS. 3A and 3B, a flow flap 106 is now provided by means of which the inflow velocity of the propeller 103 can be influenced. The inflow direction A is shown schematically in FIG. 3B. In some embodiments, two or more flow flaps 106 can also be provided.

The flow flap 106 can be arranged in the direction of flow in front of and/or behind the plane formed by the propeller 103, wherein a pivot axis of the flow flap 106 can be aligned vertically and/or horizontally. However, FIG. 3C shows the positioning of the flow flap 106 in the direction of flow in front of the propeller in the inflow area.

In FIG. 3D, in some embodiments, three (i.e. several) guide vanes 107 are provided in the cort nozzle 105 of FIG. 3A, by means of which the inflow velocity of the propeller 103 can be influenced.

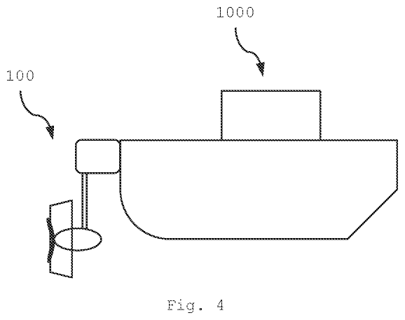

FIG. 4 schematically shows a watercraft 1000 with the propulsion system 100 as shown in FIGS. 3A and 3B. The watercraft 1000 can be a boat or a ship.

To drive the watercraft 1000, the propulsion system 100 can generate thrust in a thrust state. In a generator state, which here is a hydrogeneration state in which energy is obtained by hydrogeneration, the propulsion system 100 can also be used to convert flow energy into electrical energy.

The apparatus 10 of the propulsion system 100, which implements the method 1 according to FIG. 1, adjusts the flow properties based on the determined operation state of the propulsion system 100.

### LIST OF REFERENCE SIGNS

1 Method
2 Determining the operation state
3 Adjusting the flow properties
10 Apparatus
11 Module
12 Adjustment means
100 Propulsion system
101 Electric motor/generator
102 Gearbox
103 Propeller
104 Propeller blade
105 Cort nozzle
106 Flow flap
107 Guide vane
1000 Watercraft
A Inflow direction

Where applicable, any of the individual features shown in the embodiments may be combined and/or interchanged without departing from the scope of the disclosure.

1. A method for adjusting flow properties of a propeller of a propulsion system for watercrafts in particular for boats and ships, depending on the operation state, comprising the steps:
determining the operation state of the propulsion system, wherein in the propulsion system there is present either a thrust state or a free state or a blocked state or a generator state, in particular a hydrogeneration state for obtaining energy by hydrogeneration;
adjusting the flow properties of the propeller based on the determined operation state.

2. The method according to claim 1, characterized in that the operation state of the propulsion system is initially set by a user and the user preferably sets a thrust state and/or a free state and/or a blocked state and/or a generator state as the operation state.

3. The method according to claim 1, wherein when adjusting the flow properties, based on the determined operation state, a propeller shape of the propeller is adjusted and/or an inflow velocity of the propeller is adjusted.

4. The method according to claim 3, wherein the propeller shape of the propeller is changed by changing an angle of attack of at least one propeller blade of the propeller and/or by changing an inflow area of at least one propeller blade and/or by changing the number of propeller blades and/or by changing the profile thickness depending on the radius of at least one propeller blade and/or by changing the profile camber of at least one propeller blade and/or by changing the blade retraction of at least one propeller blade and/or by changing the skew of at least one propeller blade.

5. The method according to claim 3, in that wherein the inflow velocity is adjusted by means of a cort nozzle.

6. The method according to claim 5, wherein a diameter of a nozzle outlet of the cort nozzle is adjusted.

7. The method according to claim 4, wherein the diameter of the nozzle outlet is adjusted by means of rotation of blades or planes of the cort nozzle.

8. The method according to claim 3, wherein the inflow velocity of the propeller is adjusted by means of at least one flow flap, wherein the flow flap is preferably arranged upstream and/or downstream of the plane formed by the propeller in the direction of flow, wherein a pivot axis of the flow flap is particularly preferably aligned vertically and/or horizontally.

9. The method according to claim 3, wherein the orientation of at least one guide vane is varied to adjust the inflow of the propeller.

10. An apparatus for adjusting flow properties of a propeller of a propulsion system for watercrafts depending on the operation state, comprising:
a module for determining an operation state, wherein the module is configured and arranged to determine the operation state of the propulsion system, wherein in the propulsion system either a thrust state or a free state or a blocked state or a generator state, in particular a hydrogeneration state for generating energy by hydrogeneration, is present;
adjustment means for adjusting the flow properties of the propeller, wherein the adjustment means are configured and arranged to adjust the flow properties based on the determined operation state.

11. An apparatus according to claim 10, wherein a setting apparatus is provided for setting the operation state of the propulsion system by a user, and the user can preferably set a thrust state and/or a free state and/or a blocked state and/or a generator state as the operation state via the setting apparatus.

12. The apparatus according to claim 10, wherein the adjustment means comprise a propeller configured and arranged to change its propeller shape and/or the adjustment means are configured and arranged to adjust an inflow velocity of the propeller.

13. An apparatus according to claim 12, wherein the propeller is configured and arranged to adjust an angle of attack of at least one propeller blade of the propeller and/or an area of at least one propeller blade and/or a number of propeller blades and/or a profile thickness depending on the radius of at least one propeller blade and/or a profile camber of at least one propeller blade and/or a blade retraction of at least one propeller blade and/or the skew of at least one propeller blade.

14. An apparatus according to claim 10, wherein the adjustment means comprise a cort nozzle configured and arranged to adjust the inflow velocity of the propeller.

15. An apparatus according to claim 14, wherein the cort nozzle is configured and arranged to adjust a diameter of a nozzle outlet of the cort nozzle.

16. An apparatus according to claim 15, wherein the cort nozzle is configured and arranged to adjust the diameter of the nozzle outlet by means of rotation of vanes or planes of the cort nozzle.

17. An apparatus according to claim 14, characterized in that wherein the cort nozzle is movable along the propeller axis.

18. An apparatus according to claim 10, wherein at least one flow flap is provided for adjusting the inflow velocity of the propeller, wherein the flow flap is preferably arranged in the direction of flow in front of and/or behind the plane formed by the propeller, wherein a pivot axis of the flow flap is particularly preferably oriented vertically and/or horizontally.

19. An apparatus according to claim 14, wherein by at least one guide vane the inflow velocity of the propeller is influenced, wherein the at least one guide vane can be fixedly or movably mounted in the cort nozzle or on the flow flap.

20. An apparatus according to claim 10, characterized in that wherein the propeller is connected via a shiftable transmission to a generator for generating energy by hydrogeneration, and wherein an adaptation apparatus is provided for adapting the working point of the transmission depending on the efficiency.

21. An apparatus according to claim 10, wherein the propeller of the propulsion can be pivoted about a vertical pivot axis, preferably pivoted by 180°, so that depending on the respective operation mode an advantageous inflow direction of the propeller is active.

22. A propulsion system for watercrafts, comprising an apparatus for adjusting flow properties of a propeller of a propulsion system for watercrafts depending on the operation state, comprising:
a module for determining an operation state, wherein the module is configured and arranged to determine the operation state of the propulsion system, wherein in the propulsion system either a thrust state or a free state or a blocked state or a generator state, in particular a hydrogeneration state for generating energy by hydrogeneration, is present;
adjustment means for adjusting the flow properties of the propeller, wherein the adjustment means are configured and arranged to adjust the flow properties based on the determined operation state.

23. A watercraft comprising a propulsion system comprising an apparatus for adjusting flow properties of a propeller of a propulsion system for watercrafts depending on the operation state, comprising:
a module for determining an operation state, wherein the module is configured and arranged to determine the operation state of the propulsion system, wherein in the propulsion system either a thrust state or a free state or a blocked state or a generator state, in particular a hydrogeneration state for generating energy by hydrogeneration, is present;
adjustment means for adjusting the flow properties of the propeller, wherein the adjustment means are configured and arranged to adjust the flow properties based on the determined operation state.

24. The watercraft according to claim 23, wherein the watercraft is a boat or a ship.
